(19) United States
(12) Patent Application Publication
(10) Pub. No.: US 2024/0224325 A1
(43) Pub. Date: Jul. 4, 2024

(54) DATA AMOUNT DETERMINATION METHOD AND APPARATUS, AND THRESHOLD CONFIGURATION METHOD AND APPARATUS

(71) Applicant: Beijing Xiaomi Mobile Software Co., Ltd., Beijing (CN)

(72) Inventor: Xiaowei JIANG, Beijing (CN)

(21) Appl. No.: 18/552,848

(22) PCT Filed: Apr. 1, 2021
(86) PCT No.: PCT/CN2021/085087

§ 371 Date: Mar. 12, 2024

(51) Int. Cl. H04W 74/0808

(52) U.S. Cl. CPC H04W 74/0808

(57) ABSTRACT

A data amount determination method, including: determining a candidate radio bearer (RB) capable of triggering small data transmission (SDT); determining a first data amount of uplink data to be transmitted from the candidate RB, determining a second data amount of packet header required to be added for transmission of the uplink data, and determining a third data amount of auxiliary information required to be transmitted along with the uplink data; and determining, according to the first data amount, the second data amount and the third data amount, a total data amount of data required to be transmitted from the candidate RB.

### BACKGROUND

A terminal can carry out small data transmission (SDT) in an unconnected state according to a resource configured by a network, so as to recover connection.

The network can configure radio bearers (RBs) capable of triggering the SDT for the terminal. If uplink data to be transmitted is found in some of those RBs, and a total data amount of the uplink data to be transmitted and related data satisfies the requirement for triggering the SDT, the SDT can be triggered.

### SUMMARY

Examples of the disclosure provide a method for determining a data amount, a method for configuring a threshold, an apparatus for determining a data amount, an apparatus for configuring a threshold, a communication apparatus and a computer-readable storage medium.

A first aspect of an example of the disclosure provides a method for determining a data amount. The method for determining a data amount includes:
determining a candidate radio bearer (RB) capable of triggering small data transmission (SDT);
determining a first data amount of uplink data to be transmitted from the candidate RB, determining a second data amount of a packet header required to be added for transmission of the uplink data, and determining a third data amount of auxiliary information required to be transmitted along with the uplink data; and
determining, according to the first data amount, the second data amount and the third data amount, a total data amount of data required to be transmitted from the candidate RB.

A second aspect of an example of the disclosure provides a method for configuring a threshold. The method for configuring a threshold includes:
configuring corresponding data amount thresholds for candidate SDT types of a terminal, such that the terminal determines an available SDT type for transmitting uplink data from the candidate SDT types according to relations between a total data amount required to be transmitted from a candidate RB and the data amount thresholds; where
the total data amount is determined on the basis of a first data amount of the uplink data to be transmitted from the candidate RB, a second data amount of a packet header required to be added for transmission of the uplink data, and a third data amount of auxiliary information required to be transmitted along with the uplink data.

A third aspect of an example of the disclosure provides a communication apparatus. The communication apparatus includes:
a processor; and
a memory used for storing a processor-executable instruction; where
the processor is configured to execute the above method for determining a data amount.

A fourth aspect of an example of the disclosure provides a communication apparatus. The communication apparatus includes:
a processor; and
a memory used for storing a processor-executable instruction; where
the processor is configured to execute the above method for configuring a threshold.

A fifth aspect of an example of the disclosure provides a computer-readable storage medium. The computer-readable storage medium is used for storing a computer program, where the computer program implements steps of the above method for determining a data amount when executed by a processor.

A sixth aspect of an example of the disclosure provides a computer-readable storage medium. The computer-readable storage medium is used for storing a computer program, where the computer program implements steps of the above method for configuring a threshold when executed by a processor.

### BRIEF DESCRIPTION OF THE DRAWINGS

In order to describe technical solutions in examples of the disclosure more clearly, accompanying drawings required for describing the examples will be briefly introduced below. Apparently, the accompanying drawings in the following description show merely some examples of the disclosure, and those of ordinary skill in the art would also be able to derive other accompanying drawings from these accompanying drawings without making creative efforts.

FIG. 1 is a schematic flow diagram of a method for determining a data amount shown according to an example of the disclosure.

FIG. 2 is a schematic flow diagram of another method for determining a data amount shown according to an example of the disclosure.

FIG. 3 is a schematic flow diagram of yet another method for determining a data amount shown according to an example of the disclosure.

FIG. 4 is a schematic flow diagram of yet another method for determining a data amount shown according to an example of the disclosure.

FIG. 5 is a schematic flow diagram of yet another method for determining a data amount shown according to an example of the disclosure.

FIG. 6 is a schematic flow diagram of yet another method for determining a data amount shown according to an example of the disclosure.

FIG. 7 is a schematic flow diagram of yet another method for determining a data amount shown according to an example of the disclosure.

FIG. 8 is a schematic flow diagram of a method for configuring a threshold shown according to an example of the disclosure.

FIG. 9 is a schematic flow diagram of another method for configuring a threshold shown according to an example of the disclosure.

FIG. 10 is a schematic flow diagram of yet another method for configuring a threshold shown according to an example of the disclosure.

FIG. 11 is a schematic block diagram of an apparatus for determining a data amount shown according to an example of the disclosure.

FIG. 12 is a schematic block diagram of another apparatus for determining a data amount shown according to an example of the disclosure.

FIG. 13 is a schematic block diagram of yet another apparatus for determining a data amount shown according to an example of the disclosure.

FIG. 14 is a schematic block diagram of an apparatus for configuring a threshold shown according to an example of the disclosure.

FIG. 15 is a schematic block diagram of an apparatus for configuring a threshold shown according to an example of the disclosure.

FIG. 16 is a schematic block diagram of an apparatus for determining a data amount shown according to an example of the disclosure.

### DETAILED DESCRIPTION

Technical solutions of examples of the disclosure will be clearly and completely described in combination with accompanying drawings of the examples of the disclosure. Apparently, the described examples are merely some examples rather than all examples of the disclosure. On the basis of examples of the disclosure, all other examples obtained by those of ordinary skill in the art without making creative efforts fall within the scope of protection of the disclosure.

Terms used in examples of the disclosure are merely to describe particular examples, and are not intended to limit examples of the disclosure. The singular forms such as “a”, “an” and “the” used in examples of the disclosure and the appended claims are also intended to include plural forms, unless otherwise clearly stated in the context. It should also be understood that the term “and/or” used here refers to and includes any or all possible combinations of one or more of associated listed items.

It should be understood that although the terms “first”, “second”, “third”, etc. may be employed in examples of the disclosure to describe all types of information, such information should not be limited to these terms. These terms are merely used for distinguishing the same type of information from each other. For instance, first information can also be referred to as second information, and similarly, second information can also be referred to as first information, without departing from the scope of examples of the disclosure. Depending on the context, the word “if” as used here can be interpreted as “when”, “at the time of” or “in response to determining”.

For purposes of concision and ease of understanding, the terms “greater than” or “less than”, “higher than” or “lower than” are used here to represent size relations. Those skilled in that art can understand that the term “greater than” also encompasses the meaning of “greater than or equal to” and “less than” also encompasses the meaning of “less than or equal to”; and term “higher than” also encompasses the meaning of “higher than or equal to” and “lower than” also encompasses the meaning of “lower than or equal to”.

The disclosure relates to the technical field of communications. Uplink data to be transmitted is diverse, so is its related data. In consequence, it is difficult to accurately determine the total data amount and determine whether the requirement for triggering the SDT is satisfied. Thus, SDT failure or delay is likely to occur. As for this, the disclosure provides a method for determining a data amount, a method for configuring a threshold, an apparatus for determining a data amount, an apparatus for configuring a threshold, a communication apparatus and a computer-readable storage medium.

FIG. 1 is a schematic flow diagram of a method for determining a data amount shown according to an example of the disclosure. The method for determining a data amount shown in the example may be suitable for a terminal, and the terminal includes but is not limited to a communication apparatus such as a mobile phone, a tablet computer, a wearable device, a sensor and an internet of things device. The terminal may be used as user equipment to be in communication with a network-side device, the network-side device is, for instance, a base station or a core network, and the base station includes but is not limited to a base station in a communication system, such as a 4G base station, a 5G base station and a 6G base station.

In an example, the base station may be a network-side device which the method for configuring a threshold in any one of the subsequent examples is suitable for.

As shown in FIG. 1, the method for determining a data amount may include steps as follows:
step S101: determine a candidate radio bearer (RB) (the RB may be an RB in a suspended state) capable of triggering small data transmission (SDT);
step S102: determine a first data amount of uplink data to be transmitted from the candidate RB, determine a second data amount of a packet header required to be added for transmission of the uplink data, and determine a third data amount of auxiliary information required to be transmitted along with the uplink data; and
step S103: determine, according to the first data amount, the second data amount and the third data amount, a total data amount of data required to be transmitted from the candidate RB.

In an example, a network (such as a base station and a core network) may configure a candidate SDT type, a candidate RB and a data amount threshold for a terminal.

The candidate SDT type refers to an SDT type that the terminal may select during the SDT, and includes but is not limited to at least one of:
type 1 for short, in which message (Msg)3 in a 4-step random access process of initial access carries data to be transmitted in an SDT process;
type 2 for short, in which MsgA in a 2-step random access process of initial access carries data to be transmitted in an SDT process; or
type 3 for short, in which a dedicated uplink resource configured by a network carries data to be transmitted in an SDT process, and the dedicated uplink resource may be a configure grant (CG) uplink resource or a preallocated uplink resource (PUR).

The candidate RB may be a data radio bearer (DRB) or a signaling radio bearer (SRB).

The DRB is used for transmitting service data of the terminal; and the SRB is used for transmitting a radio resource control (RRC) signaling, and may include SRB0, SRB1, SRB2, SRB3, etc.

In an example, a network may configure candidate RBs and data amount thresholds corresponding to the candidate SDT types for a terminal. One candidate SDT type corresponds to at least one candidate RB and one data amount threshold, and may correspond to a plurality of RBs and a plurality of data amount thresholds. Under the circumstance that one candidate SDT type corresponds to a plurality of RBs and a plurality of data amount thresholds, the plurality of data amount thresholds are in one-to-one correspondence with the plurality of RBs.

In an example, the terminal may determine a first data amount of uplink data to be transmitted (that is, the uplink data) in each candidate RB. In order to transmit the uplink data, in addition to transmitting the uplink data, a packet header is required to be added for the uplink data, and a second data amount of the packet header that is required to be added for the uplink data may be determined. Moreover, auxiliary information is required to be transmitted along with the uplink data in the SDT process, and a third data amount of the auxiliary information may be determined.

That is, when uplink data to be transmitted exists in the candidate RB, not only the uplink data is required to be transmitted actually, but also a packet header required to be added for the uplink data and auxiliary information required to be transmitted along with the uplink data.

According to examples of the disclosure, when uplink data to be transmitted exists in a candidate RB, a total data amount of data to be transmitted from the candidate RB may be determined according to a first data amount of the uplink data, a second data of a packet header required to be added for the uplink data, and a third data amount of auxiliary information required to be transmitted along with the uplink data.

Accordingly, the data amount of the data required to be transmitted from the candidate RB can be accurately determined such that whether a requirement for triggering the SDT is satisfied can be accurately determined subsequently according to the determined data amount. When the requirement for triggering the SDT is satisfied, the uplink data can be transmitted in time through the SDT such that problems of SDT failure, SDT delay, etc. can be avoided. When the requirement for triggering the SDT is not satisfied, the SDT can be accurately canceled or delayed such that resource waste caused by erroneous transmission of the uplink data through the SDT can be avoided.

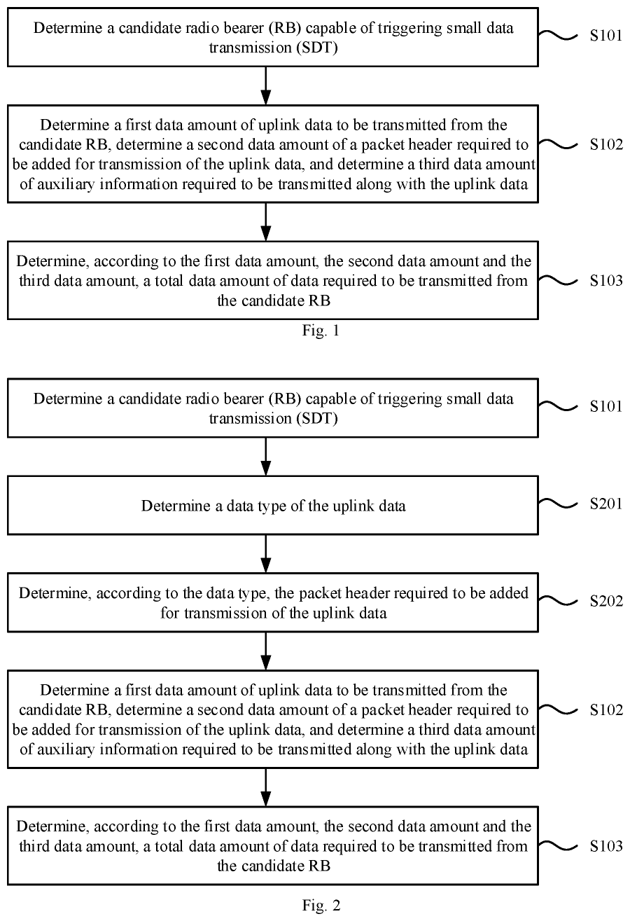

FIG. 2 is a schematic flow diagram of another method for determining a data amount shown according to an example of the disclosure. As shown in FIG. 2, in some examples, the method further includes:
step S201: determine a data type of the uplink data; and
step S202: determine, according to the data type, the packet header required to be added for transmission of the uplink data.

In an example, the data type of the uplink data includes at least one of:
a service data adaptation protocol (SDAP) protocol data unit (PDU);
a packet data convergence protocol (PDCP) PDU; or
a media access control (MAC) PDU.

Different packet headers are required to be added for uplink data of different data types. The data type may include a type of a data unit to be formed by the uplink data, such as an MAC PDU and an SDAP PDU.

For instance, in the case that the uplink data is an MAC PDU, packet headers required to be added for an MAC service data unit (SDU) including the uplink data include an SDAP packet header, a PDCP packet header, a radio link control (RLC) packet header and an MAC packet header, such that the MAC PDU is formed.

In the case that the uplink data is an SDAP PDU, a packet header required to be added for the SDAP SDU including the uplink data includes an SDAP packet header, such that the SDAP PDU is formed.

Thus, the packet header required to be added for the uplink data may be determined according to the data type of the uplink data, and further a second data amount of the packet header required to be added is determined. Accordingly, the data amount of the packet header can be accurately determined, and further the total data amount of the data required to be transmitted from the candidate RB can be accurately determined.

In an example, since the type of the candidate RB may also affect the data amount of the packet header, the data type may further include a type of a candidate RB in which the uplink data is located. For instance, in the case that the type of the candidate RB is SRB2, when the PDCP packet header is required to be added, the data amount of the PDCP packet header is 8 bits. In the case that the type of the candidate RB is DRB, when the PDCP packet header is required to be added, the data amount of the PDCP packet header is required to be determined according to a length of a PDCP sequence number (SN) configured by a network, and may be 16 bits or 18 bits.

In addition, the terminal may agree with the network on no addition of a packet header for any one of the above-mentioned layers. For instance, if the terminal agrees with the network on addition of a packet header for an SDAP layer, an SDAP packet header is added, and a data amount of the SDAP packet header is 8 bits. If the terminal agrees with the network on no addition of a packet header, no SDAP packet header is added, and a data amount of the SDAP packet header is not required to be computed when a second data amount is computed.

It should be noted that when the uplink data occupies one data unit mentioned above, a data amount of the one data unit mentioned above may be computed. When the uplink data occupies a plurality of data units mentioned above, a data amount of the plurality of data units may be computed. For instance, when the uplink data occupies one PDCP SDU, a second data amount of a packet header required to be added for the one PDCP SDU and a first data amount of the one PDCP SDU may be determined. When the uplink data occupies a plurality of PDCP SDUs (or a plurality of different types of data units, such as one PDCP SDU and one SDAP SDU), a second data amount of a packet header required to be added for the plurality of PDCP SDUs and a first data amount of the plurality of PDCP SDUs may be determined.

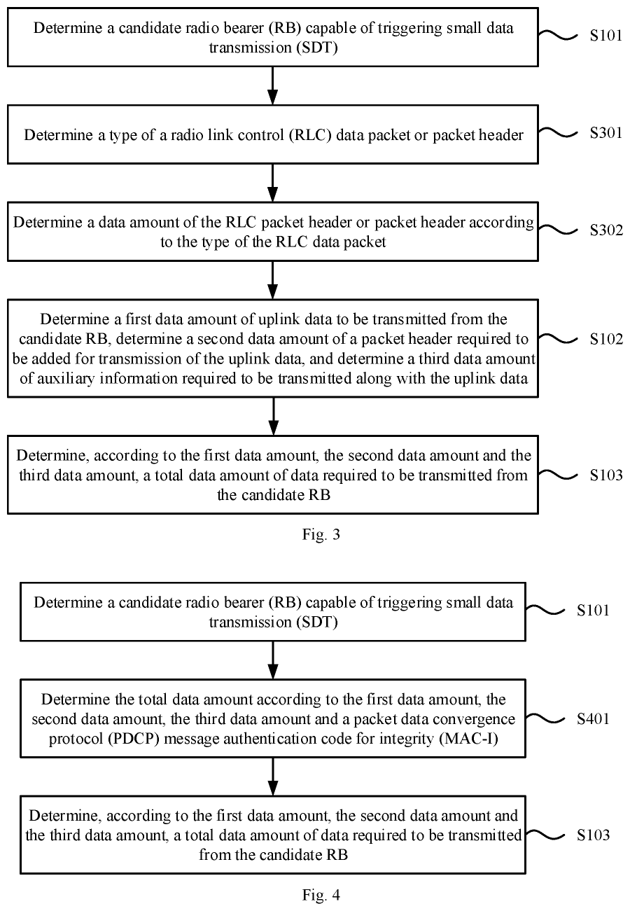

FIG. 3 is a schematic flow diagram of yet another method for determining a data amount shown according to an example of the disclosure. As shown in FIG. 3, in some examples, the packet header at least includes a radio link control (RLC) packet header, and the method further includes:
step S301: determine a type of an RLC data packet or packet header; and
step S302: determine a data amount of the RLC data packet according to the type of the RLC data packet or packet header.

In an example, a plurality of types of RLC packet headers exist, such as an RLC packet header including a complete RLC SDU and an RLC packet header including an incomplete RLC SDU. Different types of RLC packet headers have different data amounts, and thus the data amount of the RLC packet header required to be added for the uplink data may be determined according to the type of the RLC packet header.

The type of the RLC packet header may be determined by an agreement between the terminal and the base station, or may be specified by a protocol.

In an example, a plurality of types of RLC data packets exist, such as an RLC PDU including a complete RLC SDU and an RLC PDU including an incomplete RLC SDU. RLC packet headers corresponding to different types of RLC data packets have different data amounts, and thus the data amount of the RLC packet header required to be added for the uplink data may be determined according to the type of the RLC packet header.

The type of the RLC data packet may be determined by an agreement between the terminal and the base station, or may be specified by a protocol.

In some examples, the step of determining a third data amount of auxiliary information required to be transmitted along with the uplink data includes:
determine a type of the auxiliary information; and
determine the third data amount according to the type of the auxiliary information.

In an example, the type of the auxiliary information includes but is not limited to RRC-based SDT and RRC-less SDT, and different types of auxiliary information may have different data amounts. Thus, the third data amount of the auxiliary information required to be added for the uplink data may be determined according to the type of the auxiliary information.

Auxiliary information of the RRC-based SDT type is an RRC message, and the data amount of the type of auxiliary information includes a data amount of the auxiliary information itself and a data amount of an MAC packet header required to be added for the auxiliary information. For instance, in the case that the auxiliary information is RRC Resume Request, the data amount is 48 bits (or 64 bits, and 48 bits are taken as an instance here), the data amount of the MAC packet header required to be added for the auxiliary information is 8 bits, and the third data amount is 56 bits.

Auxiliary information of the RRC-less SDT type is an MAC control element (CE), and a data amount of the type of auxiliary information includes a data amount of the auxiliary information itself and a data amount of an MAC packet header required to be added for the auxiliary information. For instance, in the case that the auxiliary information is a short user equipment (UE) identifier (ID) (or a full UE ID, and the Short UE ID is taken as an instance here), the data amount is 40 bits, which include 24 bits of short inactive radio network temporary identifier (I-RNTI) and 16 bits of resume message authentication code for integrity (MAC-I), a data amount of the MAC packet header required to be added for the auxiliary information is 8 bits, and the third data amount is 48 bits.

The auxiliary information of the RRC-less SDT type may be a physical channel identifier, and under the circumstance, the data amount of the auxiliary information is 0.

FIG. 4 is a schematic flow diagram of yet another method for determining a data amount shown according to an example of the disclosure. As shown in FIG. 4, in some examples, the step of determining, according to the first data amount, the second data amount and the third data amount, a total data amount of data required to be transmitted from the candidate RB includes:
step S401: determine the total data amount according to the first data amount, the second data amount, the third data amount and a packet data convergence protocol (PDCP) message authentication code for integrity (MAC-I).

In an example, when the total data amount is computed, a message authentication code for integrity (MAC-I) may also be considered in addition to the first data amount, the second data amount and the third data amount. By adding the PDCP MAC-I for the uplink data, integrity of the uplink data may be verified by a network side.

In an example, the method further includes:
delete, in response to determining that a type of the candidate RB is SRB 2, the PDCP MAC-I in a process of triggering the SDT.

Under the circumstance that the type of the candidate RB is SRB2, resume MAC-I fixedly exits in the auxiliary information added for the uplink data generally, and the resume MAC-I and the PDCP MAC-I have the same function. Thus, when the uplink data is transmitted in the SDT process, the PDCP MAC-I is not required to be added for the uplink data, that is, the PDCP MAC-I in a PDCP layer is deleted.

Under this circumstance, uplink resources can be saved such that other uplink data required to be transmitted can be transmitted by means of the saved uplink resources.

Further, after the SDT process ends, information of SRB2 transmitted by the terminal subsequently is required to carry PDCP MAC-I. Since the PDCP MAC-I and the resume MAC-I have some same functions, and also have some different functions, and the SDT process is sensitive to the data amount of data to be transmitted, the PDCP MAC-I is deleted. After the SDT process ends, the PDCP MAC-I may be retained in other uplink processes that are not sensitive to the data amount of data to be transmitted such that functions of the PDCP MAC-I can be completely implemented.

A determination condition for an end of the SDT process may be different on the basis of different SDT types.

In the case that the SDT type is type 1 mentioned above, the determination condition for a successful end of the SDT process is that the terminal determines that contention resolution is successful after receiving Msg4.

In the case that the SDT type is type 2 mentioned above, the determination condition for a successful end of the SDT process is that the terminal determines that contention resolution is successful after receiving MsgB.

In the case that the SDT type is type 3 mentioned above, the determination condition for a successful end of the SDT process is that the terminal receives a confirmation message from the network for the transmitted data, such as a cell-radio network temporary identifier (C-RNTI) physical downlink control channel (PDCCH).

A condition for a failed end of the SDT includes but is not limited to a condition that the number of times of the SDT reaches a threshold of the number of times, and a condition that duration of the SDT reaches a duration threshold.

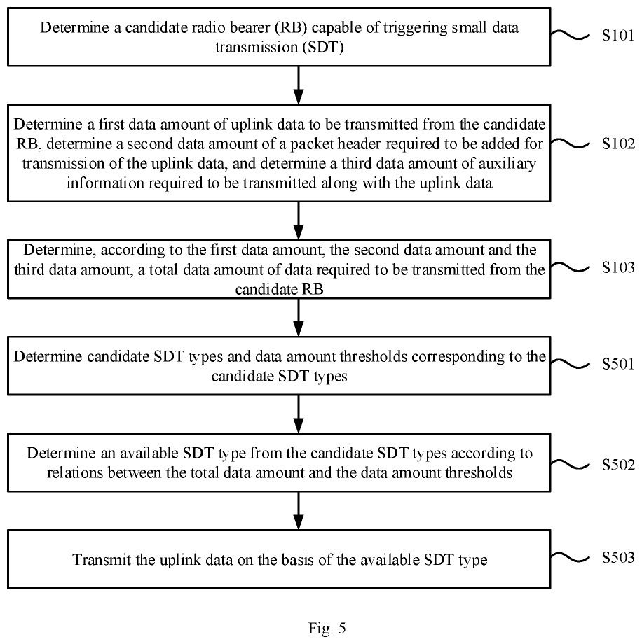

FIG. 5 is a schematic flow diagram of yet another method for determining a data amount shown according to an example of the disclosure. As shown in FIG. 5, in some examples, the method further includes:
step S501: determine candidate SDT types and data amount thresholds corresponding to the candidate SDT types;
step S502: determine an available SDT type from the candidate SDT types according to relations between the total data amount and the data amount thresholds; and
step S503: transmit the uplink data on the basis of the available SDT type.

In an example, the network may configure candidate RBs and data amount thresholds corresponding to the candidate SDT types for the terminal, and the terminal may determine, by means of the configured data amount thresholds, when uplink data exists in the candidate RB, whether the total data amount of data required to be transmitted from the candidate RB can trigger the SDT and which type of SDT can be triggered.

The total data amount of the data to be transmitted by the candidate RB may be compared with the data amount thresholds corresponding to all the types, a target threshold greater than or equal to the total data amount is determined from the data amount thresholds, an SDT type corresponding to the target threshold is selected as an available SDT type, and further the uplink data is transmitted on the basis of the SDT type.

For instance, the SDT type configured by the network for the terminal includes the above-mentioned three types. A data amount threshold corresponding to type 1 is 100 bytes, a data amount threshold corresponding to type 2 is 200 bytes, and a data amount threshold corresponding to type 3 is 150 bytes. The total data amount of the data required to be transmitted from the candidate RB is 180 bytes, which is less than the data amount threshold corresponding to type 2. Thus, type 2 may be selected as the available SDT type, and the uplink data is transmitted on the basis of type 2.

In an example, the step of determining data amount thresholds corresponding to the candidate SDT types includes:
determine the data amount thresholds corresponding to the candidate SDT types according to an explicit indication, or determine the data amount thresholds corresponding to the candidate SDT types according to an implicit indication.

The network may explicitly indicate the data amount thresholds corresponding to the candidate SDT types. For instance, configuration information may carry an identifier of an SDT type and a data amount threshold corresponding to the identifier such that the data amount thresholds corresponding to all the identified SDT types may be explicitly indicated.

The network may implicitly indicate the data amount thresholds corresponding to the candidate SDT types. For instance, the network may agree with the terminal, or a protocol specifies that the terminal determines the data amount thresholds on the basis of specific information transmitted by the network.

It should be noted that in the above-mentioned example, whether to transmit the uplink data by means of the available SDT type is finally determined according to the relations between the total data amount and the data amount thresholds corresponding to all SDT types.

In another example, a data amount threshold corresponding to a candidate SDT type corresponding to a candidate RB for transmitting the uplink data may be determined, the total data amount is only compared with the data amount threshold, and whether to transmit the uplink data by means of the candidate SDT type is determined according to a comparison result. For instance, in the case that the total data amount is less than the data amount threshold, the uplink data is transmitted by means of the candidate SDT type, and further connection recovery is performed. Otherwise, the connection recovery is performed by other methods, such as random access, instead of transmitting the uplink data through the SDT.

In an example, the step of determining the data amount thresholds corresponding to the candidate SDT types according to an implicit indication includes:
determine transport block sizes or MAC PDU sizes corresponding to uplink configuration information for configuring resources for the candidate SDT types; and
determine the data amount thresholds corresponding to the candidate SDT types according to the transport block sizes.

In an example, the network may agree with the terminal, or a protocol specifies that the terminal determines a data amount threshold corresponding to a candidate SDT type according to a transport block size or an MAC PDU size corresponding to uplink configuration information for configuring a resource for the candidate SDT type.

The network may configure resources during SDT by means of configuration information for all the candidate SDT types, and the configuration information may be uplink (UL) grant. For instance, in the case of type 2 mentioned above, the UL grant configures a resource for MsgA, a transport block size (a data amount of each transport block) or an MAC PDU size corresponding to the UL grant may be computed, and further the determined transport block size or MAC PDU size may be used as the data amount threshold corresponding to SDT of type 2. Accordingly, the data amount threshold may be implicitly indicated, and is not required to be indicated for the terminal by means of separate information, which is conducive to saving in communication resources.

In an example, the step of determining an available SDT type from the candidate SDT types according to relations between the total data amount and the data amount thresholds includes:

determine that there is no available SDT type in the candidate SDT types in response to determining that the total data amount is greater than a specified threshold of the data amount thresholds corresponding to the candidate SDT types.

In an example, the terminal determines the available SDT type according to the relations between the total data amount and the data amount thresholds corresponding to the candidate SDT types, and specifically, the total data amount may be compared with a specified threshold of all the data amount thresholds. The specified threshold may be, for instance, a maximum threshold or a minimum threshold.

For instance, when the specified threshold is the minimum threshold, if the total data amount is less than the minimum threshold of all the specified thresholds, it may be determined that all SDT types satisfy the total data amount such that the SDT type may be selected from all the SDT types. Accordingly, if the total data amount is greater than (the circumstance of being equal to may be classified as the circumstance of being greater than or less than according to requirements) the minimum threshold of all specified thresholds, it may be determined that there is no available SDT type, and SDT is not performed. Further, the connection recovery may be performed by other methods, such as random access, instead of through the SDT.

Certainly, the specified threshold may be other thresholds, for instance, the maximum threshold. If the total data amount is less than the maximum threshold of all the specified thresholds, it may be determined that at least one SDT type satisfies the total data amount such that the SDT type may be selected from all the SDT types. Accordingly, if the total data amount is greater than (the circumstance of being equal to may be classified as the circumstance of being greater than or less than according to requirements) the maximum threshold of all specified thresholds, it may be determined that there is no available SDT type, and SDT is not performed. Further, the connection recovery may be performed by other methods, such as random access, instead of through the SDT.

In some examples, the step of determining an available SDT type from the candidate SDT types according to relations between the total data amount and the data amount thresholds includes:
determine a target SDT type corresponding to a target threshold satisfying a target relation with the total data amount from the data amount thresholds corresponding to the candidate SDT types; and
determine the target SDT type as the available SDT type.

In an example, a target relation may be set according to requirements. For instance, the total data amount may be less than the data amount threshold, the total data amount may be less than or equal to the data amount threshold, or the total data amount may be less than the data amount threshold, and an absolute value of a difference between the total data amount and the data amount threshold is greater than a specified value.

For instance, in the case that the target relation is that the total data amount is less than the data amount threshold, the SDT type configured by the network for the terminal includes the above-mentioned three types. A data amount threshold corresponding to type 1 is 100 bytes, a data amount threshold corresponding to type 2 is 200 bytes, and a data amount threshold corresponding to type 3 is 150 bytes. The total data amount of the data required to be transmitted from the candidate RB is 180 bytes, which is less than the data amount threshold corresponding to type 2. Thus, type 2 may be selected as the available SDT type, and the uplink data is transmitted on the basis of type 2.

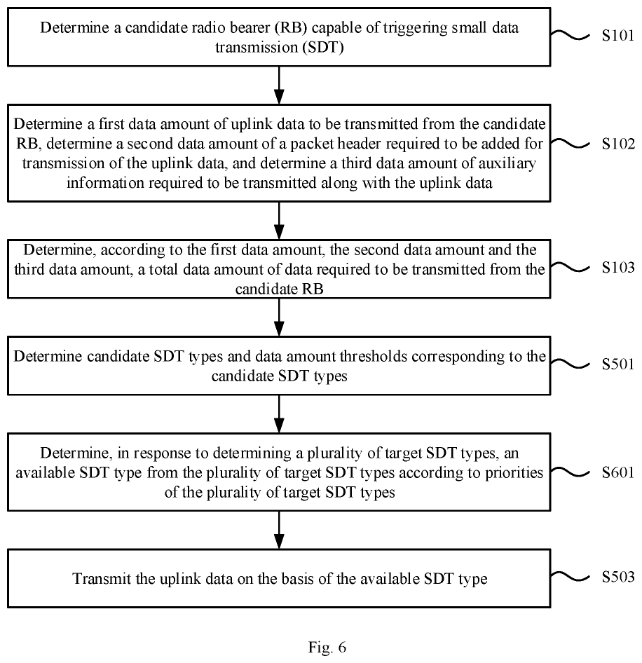

FIG. 6 is a schematic flow diagram of yet another method for determining a data amount shown according to an example of the disclosure. As shown in FIG. 6, in some examples, the step of determining the target SDT type as the available SDT type includes:
step S601: determine, in response to determining a plurality of target SDT types, the available SDT type from the plurality of target SDT types according to priorities of the plurality of target SDT types.

In an example, there may be one or more target SDT types of which relations with the total data amount satisfy the target relation. In the presence of a plurality of target SDT types, one SDT type may be selected, according to priorities of all the target SDT types, from the plurality of determined target SDT types to serve as the available SDT type. The priorities may be agreed between the network and the terminal, or may be specified by a protocol.

For instance, the priority of type 3 is the highest, the priority of type 2 is the second-highest, and the priority of type 1 is the lowest. The data amount threshold corresponding to type 1 is 100 bytes, the data amount threshold corresponding to type 2 is 200 bytes, and the data amount threshold corresponding to type 3 is 150 bytes. The total data amount of the data required to be transmitted from the candidate RB is 120 bytes, and is less than the data amount thresholds corresponding to type 3 and type 2. The plurality of target SDT types include type 3 and type 2. Since the priority of type 3 is the highest, type 3 may be selected as the available SDT type, and the uplink data is transmitted on the basis of type 3.

It should be noted that in the presence of a plurality of target SDT types, the available SDT type may be determined on the basis of other parameters in addition to determining the available SDT type on the basis of the priorities according to the above-mentioned examples.

Under the circumstance that the terminal is in communication with the network by means of a beam, as for a plurality of target SDT types, signal quality (which, for instance, may be represented by reference signal received power (RSRP)) of beams corresponding to resources configured by the network for all target SDT types may be determined, and further the available SDT type is determined on the basis of the signal quality. The signal quality may be considered separately, or the signal quality and the priority may be considered comprehensively, for instance, the two parameters are weighted and summed.

For instance, under the circumstance that the above-mentioned plurality of target SDT types include type 3 and type 2, signal quality P3 of a beam corresponding to a resource configured by a network for type 3 and signal quality P2 of a beam corresponding to a resource configured for type 2 may be determined, and a type corresponding to a beam corresponding to higher signal quality of P2 and P3 is selected as the available SDT type, which is conducive to a smooth SDT process accordingly.

The beam corresponding to the resource configured for the SDT type may be determined according to an identifier of the beam, and the identifier of the beam may be represented by a synchronous signal block (SSB) or a channel state information-reference signal (CSI-RS).

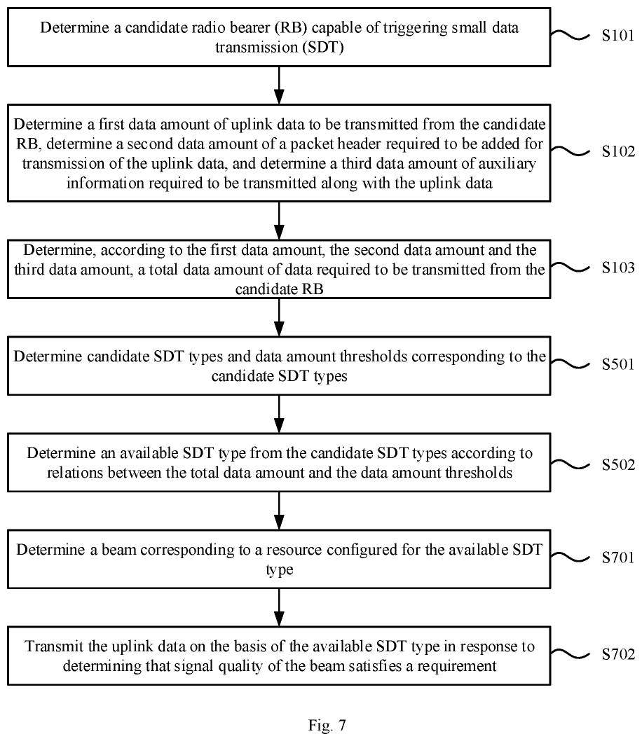

FIG. 7 is a schematic flow diagram of yet another method for determining a data amount shown according to an example of the disclosure. As shown in FIG. 7, in some examples, the step of transmitting the uplink data on the basis of the available SDT type includes:
step S701: determine a beam corresponding to a resource configured for the available SDT type; and
step S702: transmit the uplink data on the basis of the available SDT type in response to determining that signal quality of the beam satisfies a requirement.

In an example, after the available SDT type is determined, a beam corresponding to the resource configured by the network for the available SDT type and signal quality of the beam may be further determined. When the signal quality satisfies a requirement (for instance, the signal quality is greater than or equal to a signal quality threshold), uplink data is transmitted on the basis of the available SDT, and connection recovery is performed. Accordingly, communication quality in the SDT process can be ensured. When the signal quality does not satisfy the requirement, connection recovery may be performed through other methods, for instance, through random access, instead of certainly transmitting the uplink data on the basis of the available SDT.

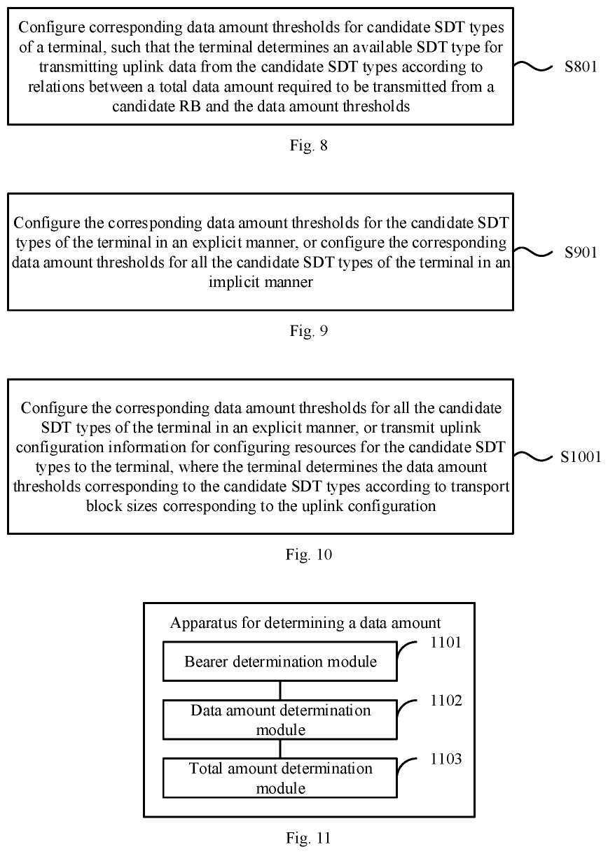

FIG. 8 is a schematic flow diagram of a method for configuring a threshold shown according to an example of the disclosure. The method for configuring a threshold shown in the example may be suitable for a network-side device, such as a base station or a core network, and the base station includes but is not limited to a base station in a communication system such as a 4G base station, a 5G base station and a 6G base station. The base station may be in communication with a terminal as user equipment, and the terminal includes but is not limited to a communication apparatus such as a mobile phone, a tablet computer, a wearable device, a sensor, and an internet of things device.

In an example, the terminal may be a terminal which the method for determining a data amount in any one of the above-mentioned examples is suitable for.

As shown in FIG. 8, the method for configuring a threshold may include steps as follows:
step S801: configure corresponding data amount thresholds for candidate SDT types of a terminal, such that the terminal determines an available SDT type for transmitting uplink data from the candidate SDT types according to relations between a total data amount required to be transmitted from a candidate RB and the data amount thresholds; where
the total data amount is determined on the basis of a first data amount of the uplink data to be transmitted from the candidate RB, a second data amount of a packet header required to be added for transmission of the uplink data, and a third data amount of auxiliary information required to be transmitted along with the uplink data.

In an example, the network (such as a base station and a core network) may configure candidate RBs and data amount thresholds corresponding to the candidate SDT types for the terminal, and the terminal may determine, by means of the configured data amount threshold, when uplink data exists in the candidate RB, whether the total data amount of data required to be transmitted from the candidate RB can trigger the SDT and which type of SDT can be triggered.

The relations between the total data amount of the data required to be transmitted by the candidate RBs and the data amount thresholds corresponding to all types may be determined. For instance, the total data amount of the data to be transmitted by the candidate RB may be compared with the data amount thresholds corresponding to all the types, a target threshold greater than or equal to the total data amount is determined from the data amount thresholds, an SDT type corresponding to the target threshold is selected as an available SDT type, and further the uplink data is transmitted on the basis of the SDT type.

For instance, the SDT type configured by the network for the terminal includes the above-mentioned three types. A data amount threshold corresponding to type 1 is 100 bytes, a data amount threshold corresponding to type 2 is 200 bytes, and a data amount threshold corresponding to type 3 is 150 bytes. The total data amount of the data required to be transmitted from the candidate RB is 180 bytes, which is less than the data amount threshold corresponding to type 2. Thus, type 2 may be selected as the available SDT type, and the uplink data is transmitted on the basis of type 2.

In an example, the network may further configure candidate SDT types and candidate RBs for the terminal.

The candidate SDT type refers to an SDT type that the terminal may select during the SDT, and includes but is not limited to at least one of:
a type in which Msg3 in a 4-step random access process of initial access carries data to be transmitted in an SDT process;
a type in which MsgA in a 2-step random access process of initial access carries data to be transmitted in an SDT process; or
a type in which a dedicated uplink resource configured by a network carries data to be transmitted in an SDT process, and the dedicated uplink resource may be a configure grant (CG) uplink resource or a preallocated uplink resource (PUR).

The candidate RB may be a data radio bearer (DRB) or a signaling radio bearer (SRB).

The DRB is used for transmitting service data of the terminal; and the SRB is used for transmitting a radio resource control (RRC) signaling, and may include SRB0, SRB1, SRB2, SRB3, etc.

In an example, a network may configure candidate RBs and data amount thresholds corresponding to the candidate SDT types for a terminal. One candidate SDT type corresponds to at least one candidate RB and one data amount threshold, and may correspond to a plurality of RBs and a plurality of data amount thresholds. Under the circumstance that one candidate SDT type corresponds to a plurality of RBs and a plurality of data amount thresholds, the plurality of data amount thresholds are in one-to-one correspondence with the plurality of RBs.

In an example, the terminal may determine a first data amount of uplink data to be transmitted (that is, the uplink data) in each candidate RB. In order to transmit the uplink data, in addition to transmitting the uplink data, a packet header is required to be added for the uplink data, and a second data amount of the packet header that is required to be added for the uplink data may be determined. Moreover, auxiliary information is required to be transmitted along with the uplink data in the SDT process, and a third data amount of the auxiliary information may be determined.

That is, when uplink data to be transmitted exists in the candidate RB, not only the uplink data is required to be transmitted actually, but also a packet header is required to be added for the uplink data and auxiliary information required to be transmitted along with the uplink data.

According to examples of the disclosure, when uplink data to be transmitted exists in a candidate RB, a total data amount of data to be transmitted from the candidate RB may be determined according to a first data amount of the uplink data, a second data of a packet header required to be added for the uplink data, and a third data amount of auxiliary information required to be transmitted along with the uplink data.

Accordingly, the data amount of the data required to be transmitted from the candidate RB can be accurately determined such that whether a requirement for triggering the SDT is satisfied can be accurately determined subsequently according to the determined data amount. When the requirement for triggering the SDT is satisfied, the uplink data can be transmitted in time through the SDT such that problems of SDT failure, SDT delay, etc. can be avoided. When the requirement for triggering the SDT is not satisfied, the SDT can be accurately canceled or delayed such that resource waste caused by erroneous transmission of the uplink data through the SDT can be avoided.

FIG. 9 is a schematic flow diagram of another method for configuring a threshold shown according to an example of the disclosure. As shown in FIG. 9, in some examples, the step of configuring corresponding data amount thresholds for candidate SDT types of the terminal includes:
step S901: configure the corresponding data amount thresholds for all the candidate SDT types of the terminal in an explicit manner, or configure the corresponding data amount thresholds for all the candidate SDT types of the terminal in an implicit manner.

In an example, the network may explicitly indicate the data amount thresholds corresponding to the candidate SDT types. For instance, configuration information may carry an identifier of an SDT type and a data amount threshold corresponding to the identifier such that the data amount thresholds corresponding to all the identified SDT types may be explicitly indicated.

The network may implicitly indicate the data amount thresholds corresponding to the candidate SDT types. For instance, the network may agree with the terminal, or a protocol specifies that the terminal determines the data amount thresholds on the basis of specific information transmitted by the network.

FIG. 10 is a schematic flow diagram of yet another method for configuring a threshold shown according to an example of the disclosure. As shown in FIG. 10, in some examples, the step of configuring corresponding data amount thresholds for candidate SDT types of the terminal in an implicit manner includes:
step S1001: transmit uplink configuration information for configuring resources for the candidate SDT types to the terminal, where the terminal determines the data amount thresholds corresponding to the candidate SDT types according to transport block sizes corresponding to the uplink configuration information.

In an example, the network may agree with the terminal, or a protocol specifies that the terminal determines a data amount threshold corresponding to a candidate SDT type according to a transport block size corresponding to uplink configuration information for configuring a resource for the candidate SDT type.

The network may configure resources during SDT by means of configuration information for all the candidate SDT types, and the configuration information may be uplink (UL) grant. For instance, in the case of type 2 mentioned above, the UL grant configures a resource for MsgA, a transport block size (a data amount of each transport block) or an MAC PDU size corresponding to the UL grant may be computed, and further the determined transport block size or MAC PDU size may be used as the data amount threshold corresponding to SDT of type 2. Accordingly, the data amount threshold may be implicitly indicated, and is not required to be indicated for the terminal by means of separate information, which is conducive to saving in communication resources.

The disclosure further provides examples of an apparatus for determining a data amount and an apparatus for configuring a threshold corresponding to the foregoing examples of the method for determining a data amount and the method for configuring a threshold.

FIG. 11 is a schematic block diagram of an apparatus for determining a data amount shown according to an example of the disclosure. The apparatus for determining a data amount shown in the example may be suitable for a terminal, and the terminal includes but is not limited to a communication apparatus such as a mobile phone, a tablet computer, a wearable device, a sensor and an internet of things device. The terminal may be used as user equipment to be in communication with a network-side device, the network-side device is, for instance, a base station or a core network, and the base station includes but is not limited to a base station in a communication system, such as a 4G base station, a 5G base station and a 6G base station.

As shown in FIG. 11, the apparatus for determining a data amount may include:
a bearer determination module 1101 configured to determine a candidate radio bearer (RB) capable of triggering small data transmission (SDT);
a data amount determination module 1102 configured to determine a first data amount of uplink data to be transmitted from the candidate RB, determine a second data amount of a packet header required to be added for transmission of the uplink data, and determine a third data amount of auxiliary information to be transmitted along with the uplink data; and
a total amount determination module 1103 configured to determine a total data amount of data required to be transmitted from the candidate RB according to the first data amount, the second data amount and the third data amount.

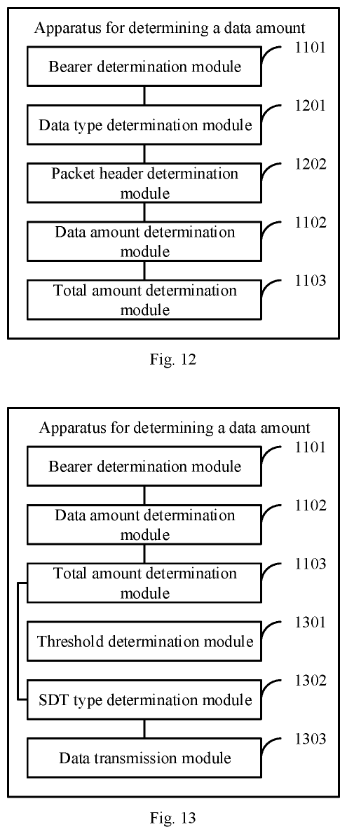

FIG. 12 is a schematic block diagram of another apparatus for determining a data amount shown according to an example of the disclosure. As shown in FIG. 12, the apparatus further includes:
a data type determination module 1201 configured to determine a data type of the uplink data; and
a packet header determination module 1202 configured to determine, according to the data type, the packet header required to be added for transmission of the uplink data.

In an example, the packet header at least includes a radio link control (RLC) packet header, and the apparatus further includes:
an RLC determination module configured to determine a type of an RLC data packet or packet header; and
an RLC data amount determination module configured to determine a data amount of the RLC packet header or packet header according to the type of the RLC data packet or packet header.

In an example, the data amount determination module is configured to determine a type of the auxiliary information; and determine the third data amount according to the type of the auxiliary information.

In an example, the data amount determination module is configured to determine the total data amount according to the first data amount, the second data amount, the third data amount and a packet data convergence protocol (PDCP) message authentication code for integrity (MAC-I).

In an example, the apparatus further includes:
a deletion module configured to delete, in response to determining that a type of the candidate RB is SRB 2, the PDCP MAC-I in a process of triggering the SDT.

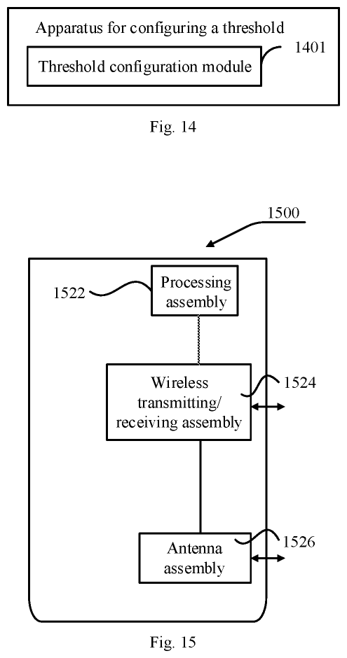

FIG. 13 is a schematic block diagram of yet another apparatus for determining a data amount shown according to an example of the disclosure. As shown in FIG. 13, the apparatus further includes:
a threshold determination module 1301 configured to determine candidate SDT types and data amount thresholds corresponding to the candidate SDT types;
an SDT type determination module 1302 configured to determine an available SDT type from the candidate SDT types according to relations between the total data amount and the data amount thresholds; and
a data transmission module 1303 configured to transmit the uplink data on the basis of the available SDT type.

In an example, the threshold determination module is configured to determine the data amount thresholds corresponding to the candidate SDT types according to an explicit indication, or determine the data amount thresholds corresponding to the candidate SDT types according to an implicit indication.

In an example, the threshold determination module is configured to determine a transport block size or an MAC PDU size corresponding to uplink configuration information of resources configured for the candidate SDT types; and determine data amount thresholds corresponding to the candidate SDT types according to the transport block sizes or the MAC PDU sizes.

In an example, the SDT type determination module is configured to determine that there is no available SDT type in the candidate SDT types in response to determining that the total data amount is greater than a specified threshold of the data amount thresholds corresponding to the candidate SDT types.

In an example, the SDT type determination module is configured to determine a target SDT type corresponding to a target threshold satisfying a target relation with the total data amount from the data amount thresholds corresponding to the candidate SDT types; and determine the target SDT type as the available SDT type.

In an example, the SDT type determination module is configured to determine, in response to determining a plurality of target SDT types, the available SDT type from the plurality of target SDT types according to priorities of the plurality of target SDT types.

In an example, the data transmission module is configured to determine a beam corresponding to a resource configured for the available SDT type; and transmit the uplink data on the basis of the available SDT type in response to determining that signal quality of the beam satisfies a requirement.

FIG. 14 is a schematic block diagram of an apparatus for configuring a threshold shown according to an example of the disclosure. The apparatus for configuring a threshold in the example may be suitable for a network-side device, such as a base station or a core network, and the base station includes but is not limited to a base station in a communication system such as a 4G base station, a 5G base station and a 6G base station. The base station may be in communication with a terminal as user equipment, and the terminal includes but is not limited to a communication apparatus such as a mobile phone, a tablet computer, a wearable device, a sensor, and an internet of things device.

As shown in FIG. 14, the apparatus for configuring a threshold may include:
a threshold configuration module 1401 configured to configure corresponding data amount thresholds for candidate SDT types of a terminal, such that the terminal determines an available SDT type for transmitting uplink data from the candidate SDT types according to relations between a total data amount required to be transmitted from a candidate RB and the data amount thresholds; where
the total data amount is determined on the basis of a first data amount of the uplink data to be transmitted from the candidate RB, a second data amount of a packet header required to be added for transmission of the uplink data, and a third data amount of auxiliary information required to be transmitted along with the uplink data.

In an example, the threshold configuration module is configured to configure the corresponding data amount thresholds for all the candidate SDT types of the terminal in an explicit manner, or configure the corresponding data amount thresholds for all the candidate SDT types of the terminal in an implicit manner.

In an example, the threshold configuration module is configured to transmit uplink configuration information for configuring resources for the candidate SDT types to the terminal, and the terminal determines the data amount thresholds corresponding to the candidate SDT types according to transport block sizes corresponding to the uplink configuration information.

A specific method of executing an operation by each module of the apparatus in the above-mentioned example is described in detail in the example of the related method, and will not be described in detail here.

Since the apparatus example substantially corresponds to the method example, the related parts can be obtained with reference to part of the description of the method example. The apparatus example described above is merely schematic, the unit described as a separate component can be physically separated or not, and a component displayed as a unit can be a physical unit or not, that is, the component can be located at one place, or distributed at a plurality of network units. Some or all of the modules can be selected according to actual requirements to achieve the purpose of the solution of the example. Those of ordinary skill in the art can understand and implement the disclosure without making creative efforts.

An example of the disclosure further provides a communication apparatus. The communication apparatus includes:
a processor; and
a memory for storing a computer program; where
the computer program implements the method for determining a data amount of any one of the above-mentioned examples when executed by the processor.

An example of the disclosure further provides a communication apparatus. The communication apparatus includes:
a processor; and
a memory for storing a computer program; where
the computer program implements the method for configuring a threshold of any one of the above-mentioned examples when executed by the processor.

An example of the disclosure further provides a computer-readable storage medium. The computer-readable storage medium is used for storing a computer program, where the computer program implements steps of the method for determining a data amount of any one of the above examples when executed by a processor.

An example of the disclosure further provides a computer-readable storage medium. The computer-readable storage medium is used for storing a computer program, where the computer program implements steps of the method for configuring a threshold of any one of the above examples when executed by a processor.

As shown in FIG. 15, a schematic block diagram of an apparatus 1500 for threshold configuration according to an example of the disclosure is shown in FIG. 15. The apparatus 1500 may be provided as a base station. With reference to FIG. 15, the apparatus 1500 includes a processing assembly 1522, a wireless transmitting/receiving assembly 1524, an antenna assembly 1526, and a signal processing portion specific to a wireless interface, and the processing assembly 1522 may further include one or more processors. One of the processors of the processing assembly 1522 may be configured to implement the method for configuring a threshold of any one of the examples.

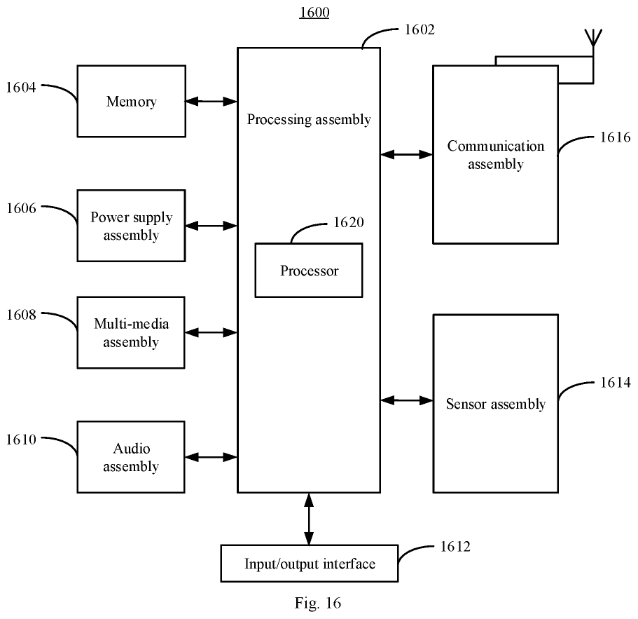

FIG. 16 is a schematic block diagram of an apparatus 1600 for data amount determination shown according to an example of the disclosure. For instance, the apparatus 1600 may be a mobile phone, a computer, a digital broadcasting terminal, a message receiving and transmitting device, a game console, a tablet device, a medical device, a fitness device, a personal digital assistant, etc.

With reference to FIG. 16, the apparatus 1600 may include one or more of assemblies as follows: a processing assembly 1602, a memory 1604, a power supply assembly 1606, a multi-media assembly 1608, an audio assembly 1610, an input/output (I/O) interface 1612, a sensor assembly 1614 and a communication assembly 1616.

The processing assembly 1602 typically controls overall operations of the apparatus 1600, such as operations associated with display, telephone call, data communication, camera operation and record operation. The processing assembly 1602 may include one or more processors 1620 to execute an instruction such that all steps or some steps of the above method for determining a data amount may be completed. Further, the processing assembly 1602 may include one or more modules such that interaction between the processing assembly 1602 and other assemblies can be facilitated. For instance, the processing assembly 1602 may include a multi-media module such that interaction between the multi-media assembly 1608 and the processing assembly 1602 can be facilitated.

The memory 1604 is configured to store various types of data such that an operation at the apparatus 1600 can be supported. Instances of such data include instructions used for any application or method operating on the apparatus 1600, such as contact data, phonebook data, messages, pictures and videos. The memory 1604 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply assembly 1606 provides power for various assemblies of the apparatus 1600. The power supply assembly 1606 may include a power supply management system, one or more power supplies, and other assemblies associated with generation, management and power distribution of the apparatus 1600.

The multi-media assembly 1608 includes a screen that provides an output interface between the apparatus 1600 and a user. In some examples, the screen may include a liquid crystal display (LCD) and a touch panel (TP). If the screen includes a touch panel, the screen may be implemented as a touch screen, so as to receive an input signal from a user. The touch panel includes one or more touch sensors, so as to sense a touch, a swipe and a gesture on the touch panel. The touch sensor can not only sense a boundary of a touch or swipe, but also measure time and pressure associated with the touch or swipe. In some examples, the multi-media assembly 1608 includes a front-facing camera and/or a rear-facing camera. When the apparatus 1600 is in an operating mode, such as a photographing mode or a video mode, the front-facing camera and/or the rear-facing camera may receive external multi-media data. Each of the front-facing camera and the rear-facing camera may be a fixed optical lens system or have focusing and optical zooming capabilities.

The audio assembly 1610 is configured to output and/or input an audio signal. For instance, the audio assembly 1610 may include a microphone (MIC) that is configured to receive an external audio signal when the apparatus 1600 is in an operating method, such as a call mode, a recording mode or a voice recognition mode. The received audio signal may be further stored in the memory 1604 or transmitted by means of the communication assembly 1616. In some examples, the audio assembly 1610 further includes a loudspeaker used for outputting the audio signal.

The I/O interface 1612 provides an interface between the processing assembly 1602 and peripheral interface modules, such as keyboards, click wheels and buttons. These buttons may include but are not limited to a home button, a volume button, a start button and a lock button.

The sensor assembly 1614 may include one or more sensors used for assessing states of various aspects of the apparatus 1600. For instance, the sensor assembly 1614 may detect an open/closed state of the apparatus 1600, and relative positioning of assemblies, such as a display and keypad of the apparatus 1600. The sensor assembly 1614 may further detect a position change of the apparatus 1600 or an assembly of the apparatus 1600, presence or absence of contact between a user and the apparatus 1600, orientation or acceleration/deceleration of the apparatus 1600, and a temperature change of the apparatus 1600. The sensor assembly 1614 may include a proximity sensor configured to detect the presence of a nearby object in the absence of any physical contact. The sensor assembly 1614 may further include a light sensor, such as a complementary metal oxide semiconductor (CMOS) or charge coupled device (CCD) image sensor for being used in imaging applications. In some examples, the sensor assembly 1614 may further include an acceleration sensor, a gyroscopic sensor, a magnetic sensor, a pressure sensor, or a temperature sensor.

The communication assembly 1616 is configured to facilitate wired or wireless communication between the apparatus 1600 and other devices. The apparatus 1600 may access a wireless network based on a communication standard, such as Wi-Fi, 2G, 3G, 4G long term evolution (LTE), 5G new radio (NR) or their combinations. In an example, the communication assembly 1616 receives a broadcast signal or broadcast related information from an external broadcast management system by means of a broadcast channel. In an example, the communication assembly 1616 further includes a near-field communication (NFC) module such that short-range communication can be facilitated. For instance, the NFC module may be implemented on the basis of a radio frequency identification (RFID) technology, an infrared data association (IrDA) technology, an ultra wideband (UWB) technology, a Bluetooth (BT) technology and other technologies.

In an example, the apparatus 1600 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic elements, so as to execute the above method for determining a data amount.

In an example, a non-transitory computer-readable storage medium including an instruction is further provided, such as a memory 1604 including an instruction. The above-mentioned instruction may be executed by the processor 1620 of the apparatus 1600, so as to complete the above-mentioned method for determining a data amount. For instance, the non-transitory computer-readable storage medium may be an ROM, a random access memory (RAM), a compact disc read-only memory (CD-ROM), a magnetic tape, a floppy disk, or an optical data storage device, etc.

Those skilled in the art could easily conceive of other implementation solutions of the disclosure upon consideration of the description and the disclosure disclosed in the implementations. The disclosure is intended to encompass any variations, uses or adaptive changes of the disclosure, which follow the general principles of the disclosure and include common general knowledge or customary technical means in the art that is not disclosed in the disclosure. The description and examples are to be regarded as illustrative merely, and the true scope and spirit of the disclosure are indicated by the following claims.

It should be understood that the disclosure is not limited to a precise structure described above and shown in accompanying drawings, and can have various modifications and changes without departing from the scope of the disclosure. The scope of the disclosure is limited by the appended claims merely.

It should be noted that the relational terms such as first and second here are merely used to distinguish one entity or operation from another entity or operation without certainly requiring or implying any such actual relation or order between such entities or operations. Terms “include” and “comprise”, or their any other variations are intended to encompass non-exclusive inclusions, such that a process, method, article, or device including a series of elements not only includes those elements, but also includes other elements that are not explicitly listed, or also includes inherent elements of such process, method, article, or device. Under the circumstance of no more limitations, an element limited by phrases “comprising a . . . ” and “including a . . . ” does not exclude other same elements in a process, method, article, or device including the element.

Methods and apparatuses provided in examples of the disclosure are described in detail above, specific instances are used here for illustrating the principles and implementations of the disclosure, and the description of the foregoing examples is merely used to help in understanding the method of the disclosure and core ideas of the disclosure. Moreover, those of ordinary skill in the art can make changes to particular embodiments and the scope of application in accordance with the ideas of the disclosure. In conclusion, the content of the description should not be understood as limiting the disclosure.

A first aspect of an example of the disclosure provides a method for determining a data amount. The method for determining a data amount includes:
determining a candidate radio bearer (RB) capable of triggering small data transmission (SDT);
determining a first data amount of uplink data to be transmitted from the candidate RB, determining a second data amount of a packet header required to be added for transmission of the uplink data, and determining a third data amount of auxiliary information required to be transmitted along with the uplink data; and
determining, according to the first data amount, the second data amount and the third data amount, a total data amount of data required to be transmitted from the candidate RB.

In some embodiments, the method further includes:
determining a data type of the uplink data; and
determining, according to the data type, the packet header required to be added for transmission of the uplink data.

In some embodiments, the packet header at least includes a radio link control (RLC) packet header, and the method further includes:
determining a type of an RLC data packet or RLC packet header; and
determining a second data amount of the RLC data packet according to the type of the RLC data packet or the RLC packet header.

In some embodiments, the determining a third data amount of auxiliary information required to be transmitted along with the uplink data includes:
determining a type of the auxiliary information; and
determining the third data amount according to the type of the auxiliary information.

In some embodiments, the determining, according to the first data amount, the second data amount and the third data amount, a total data amount of data required to be transmitted from the candidate RB includes:
determining the total data amount according to the first data amount, the second data amount, the third data amount and a packet data convergence protocol (PDCP) message authentication code for integrity (MAC-I).

In some embodiments, the method further includes:
deleting the PDCP MAC-I in a process of triggering the SDT by determining that a type of the candidate RB is signaling radio bearer (SRB) 2.

In some embodiments, the method further includes:
determining candidate SDT types and data amount thresholds corresponding to the candidate SDT types;
determining an available SDT type from the candidate SDT types according to relations between the total data amount and the data amount thresholds; and
transmitting the uplink data on the basis of the available SDT type.

In some embodiments, the determining data amount thresholds corresponding to the candidate SDT types includes:
determining the data amount thresholds corresponding to the candidate SDT types according to an explicit indication, or determining the data amount thresholds corresponding to the candidate SDT types according to an implicit indication.

In some embodiments, the determining the data amount thresholds corresponding to the candidate SDT types according to an implicit indication includes:
determining transport block sizes or media access control protocol data unit (MAC PDU) sizes corresponding to uplink configuration information for configuring resources for the candidate SDT types; and
determining the data amount thresholds corresponding to the candidate SDT types according to the transport block sizes or the MAC PDU sizes.

In some embodiments, the determining an available SDT type from the candidate SDT types according to relations between the total data amount and the data amount thresholds includes:
determining that there is no available SDT type in the candidate SDT types by determining that the total data amount is greater than a specified threshold of the data amount thresholds corresponding to the candidate SDT types.

In some embodiments, the determining an available SDT type from the candidate SDT types according to relations between the total data amount and the data amount thresholds includes:
determining a target SDT type corresponding to a target threshold satisfying a target relation with the total data amount from the data amount thresholds corresponding to the candidate SDT types; and determining the target SDT type as the available SDT type.

In some embodiments, the determining the target SDT type as the available SDT type includes:
determining the available SDT type from the plurality of target SDT types according to priorities of the plurality of target SDT types by determining a plurality of target SDT types.

In some embodiments, the transmitting the uplink data on the basis of the available SDT type includes:
determining a beam corresponding to a resource configured for the available SDT type; and
transmitting the uplink data on the basis of the available SDT type by determining that signal quality of the beam satisfies a requirement.

A second aspect of an example of the disclosure provides a method for configuring a threshold. The method for configuring a threshold includes:
configuring corresponding data amount thresholds for candidate SDT types of a terminal, such that the terminal determines an available SDT type for transmitting uplink data from the candidate SDT types according to relations between a total data amount required to be transmitted from a candidate RB and the data amount thresholds; where
the total data amount is determined on the basis of a first data amount of the uplink data to be transmitted from the candidate RB, a second data amount of a packet header required to be added for transmission of the uplink data, and a third data amount of auxiliary information required to be transmitted along with the uplink data.

In some embodiments, the configuring corresponding data amount thresholds for candidate SDT types of a terminal includes:
configuring the corresponding data amount thresholds for the candidate SDT types of the terminal in an explicit manner, or configuring the corresponding data amount thresholds for the candidate SDT types of the terminal in an implicit manner.

In some embodiments, the configuring the corresponding data amount thresholds for the candidate SDT types of the terminal in an implicit manner includes:
transmitting uplink configuration information for configuring resources for the candidate SDT types to the terminal, where the terminal determines the data amount thresholds corresponding to the candidate SDT types according to transport block sizes corresponding to the uplink configuration information.

A third aspect of an example of the disclosure provides an apparatus for determining a data amount. The apparatus for determining a data amount includes:
a bearer determination module configured to determine a candidate radio bearer (RB) capable of triggering small data transmission (SDT);
a data amount determination module configured to determine a first data amount of uplink data to be transmitted from the candidate RB, determine a second data amount of a packet header required to be added for transmission of the uplink data, and determine a third data amount of auxiliary information to be transmitted along with the uplink data; and
a total amount determination module configured to determine, according to the first data amount, the second data amount and the third data amount, a total data amount of data required to be transmitted from the candidate RB.

A fourth aspect of an example of the disclosure provides an apparatus for configuring a threshold. The apparatus for configuring a threshold includes:
a threshold configuration module configured to configure corresponding data amount thresholds for candidate SDT types of a terminal, such that the terminal determines an available SDT type for transmitting uplink data from the candidate SDT types according to relations between a total data amount required to be transmitted from a candidate RB and the data amount thresholds; where
the total data amount is determined on the basis of a first data amount of the uplink data to be transmitted from the candidate RB, a second data amount of a packet header required to be added for transmission of the uplink data, and a third data amount of auxiliary information required to be transmitted along with the uplink data.

A fifth aspect of an example of the disclosure provides a communication apparatus. The communication apparatus includes:
a processor; and
a memory used for storing a processor-executable instruction; where
the processor is configured to execute the above method for determining a data amount according to the first aspect.

A sixth aspect of an example of the disclosure provides a communication apparatus. The communication apparatus includes:
a processor; and
a memory used for storing a processor-executable instruction; where
the processor is configured to execute the above method for configuring a threshold according to the second aspect.

A seventh aspect of an example of the disclosure provides a computer-readable storage medium. The computer-readable storage medium is used for storing a computer program, where the computer program implements steps of the above method for determining a data amount according to the first aspect when executed by a processor.

An eighth aspect of an example of the disclosure provides a computer-readable storage medium. The computer-readable storage medium is used for storing a computer program, where the computer program implements steps of the above method for configuring a threshold according to the second aspect when executed by a processor.

1. A method for determining a data amount, comprising:
determining a candidate radio bearer (RB) capable of triggering small data transmission (SDT);
determining a first data amount of uplink data to be transmitted from the candidate RB, determining a second data amount of a packet header required to be added for transmission of the uplink data, and determining a third data amount of auxiliary information required to be transmitted along with the uplink data; and
determining, according to the first data amount, the second data amount and the third data amount, a total data amount of data required to be transmitted from the candidate RB.

2. The method according to claim 1, further comprising:
determining a data type of the uplink data; and
determining, according to the data type, the packet header required to be added for transmission of the uplink data.

3. The method according to claim 1, wherein the packet header at least comprises a radio link control (RLC) packet header, and the method further comprises:
determining a type of an RLC data packet or an RLC packet header; and
determining a second data amount of the RLC data packet according to the type of the RLC data packet or the RLC packet header.

4. The method according to claim 1, wherein the determining a third data amount of auxiliary information required to be transmitted along with the uplink data comprises:
determining a type of the auxiliary information; and
determining the third data amount according to the type of the auxiliary information.

5. The method according to claim 1, wherein the determining, according to the first data amount, the second data amount and the third data amount, a total data amount of data required to be transmitted from the candidate RB comprises:
determining the total data amount according to the first data amount, the second data amount, the third data amount and a packet data convergence protocol (PDCP) message authentication code for integrity (MAC-I).

6. The method according to claim 5, further comprising:
deleting the PDCP MAC-I in a process of triggering the SDT by determining that a type of the candidate RB is signaling radio bearer (SRB) 2.

7. The method according to claim 1, further comprising:
determining candidate SDT types and data amount thresholds corresponding to the candidate SDT types;
determining an available SDT type from the candidate SDT types according to relations between the total data amount and the data amount thresholds; and
transmitting the uplink data on the basis of the available SDT type.

8. The method according to claim 7, wherein the determining data amount thresholds corresponding to the candidate SDT types comprises:
determining the data amount thresholds corresponding to the candidate SDT types according to an explicit indication, or determining the data amount thresholds corresponding to the candidate SDT types according to an implicit indication.

9. The method according to claim 8, wherein the determining the data amount thresholds corresponding to the candidate SDT types according to an implicit indication comprises:
determining transport block sizes or media access control protocol data unit (MAC PDU) sizes corresponding to uplink configuration information for configuring resources for the candidate SDT types; and
determining the data amount thresholds corresponding to the candidate SDT types according to the transport block sizes or the MAC PDU sizes.

10. The method according to claim 7, wherein the determining an available SDT type from the candidate SDT types according to relations between the total data amount and the data amount thresholds comprises:
determining that there is no available SDT type in the candidate SDT types by determining that the total data amount is greater than a specified threshold of the data amount thresholds corresponding to the candidate SDT types.

11. The method according to claim 7, wherein the determining an available SDT type from the candidate SDT types according to relations between the total data amount and the data amount thresholds comprises:
determining a target SDT type corresponding to a target threshold satisfying a target relation with the total data amount from the data amount thresholds corresponding to the candidate SDT types; and
determining the target SDT type as the available SDT type.

12. The method according to claim 11, wherein the determining the target SDT type as the available SDT type comprises:
determining the available SDT type from a plurality of target SDT types according to priorities of the plurality of target SDT types.

13. The method according to claim 7, wherein the transmitting the uplink data on the basis of the available SDT type comprises:
determining a beam corresponding to a resource configured for the available SDT type; and
transmitting the uplink data on the basis of the available SDT type by determining that signal quality of the beam satisfies a requirement.

14. A method for configuring a threshold, comprising:
configuring corresponding data amount thresholds for candidate SDT types of a terminal, such that the terminal determines an available SDT type for transmitting uplink data from the candidate SDT types according to relations between a total data amount required to be transmitted from a candidate RB and the data amount thresholds; wherein
the total data amount is determined on the basis of a first data amount of the uplink data to be transmitted from the candidate RB, a second data amount of a packet header required to be added for transmission of the uplink data, and a third data amount of auxiliary information required to be transmitted along with the uplink data.

15. The method according to claim 14, wherein the configuring corresponding data amount thresholds for candidate SDT types of a terminal comprises:
configuring the corresponding data amount thresholds for the candidate SDT types of the terminal in an explicit manner, or configuring the corresponding data amount thresholds for the candidate SDT types of the terminal in an implicit manner.

16. The method according to claim 15, wherein the configuring the corresponding data amount thresholds for the candidate SDT types of the terminal in an implicit manner comprises:
transmitting uplink configuration information for configuring resources for the candidate SDT types to the terminal, wherein the terminal determines the data amount thresholds corresponding to the candidate SDT types according to transport block sizes corresponding to the uplink configuration information.

17. (canceled)

18. (canceled)

19. A communication apparatus, comprising:
a processor; and
a memory for storing a computer program; wherein
when the computer program is executed by the processor, the processor is configured to:
determine a candidate radio bearer (RB) capable of triggering small data transmission (SDT);
determine a first data amount of uplink data to be transmitted from the candidate RB, determine a second data amount of a packet header required to be added for transmission of the uplink data, and determine a third data amount of auxiliary information required to be transmitted along with the uplink data; and
determine, according to the first data amount, the second data amount and the third data amount, a total data amount of data required to be transmitted from the candidate RB.

20. A communication apparatus, comprising:
a processor; and
a memory for storing a computer program; wherein
the computer program implements the method for configuring a threshold according to claim 14 when executed by the processor.

21. A non-transitory computer-readable storage medium, used for storing a computer program, wherein the computer program implements the method for determining a data amount according to claim 1 when executed by a processor.

22. A non-transitory computer-readable storage medium, used for storing a computer program, wherein the computer program implements the method for configuring a threshold according to claim 14 when executed by a processor.
